(19) United States
(12) Patent Application Publication
(10) Pub. No.: US 2006/0195323 A1
(43) Pub. Date: Aug. 31, 2006

(54) Distributed speech recognition system

(76) Inventors: Jean Monne, Perros Guirec (FR); Jean-Pierre Petit, Minihy Treguier (FR); Patrick Brisard, Chatillon (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/550,970

(22) PCT Filed: Mar. 8, 2004
(86) PCT No.: PCT/FR04/00546

§ 371 Date: Sep. 26, 2005

(30) Foreign Application Priority Data
Mar. 25, 2003 (FR) 03/03615

(51) Int. Cl. G10L 11/00

(52) U.S. Cl. 704/270.1

(57) ABSTRACT

This invention relates to a distributed speech recognition system. The inventive system consists of: at least one user terminal comprising means for obtaining an audio signal to be recognized, parameter calculation means and control means which are used to select a signal to be transmitted; and a server comprising means for receiving the signal, parameter calculation means, recognition means and control means which are used to control the calculation means and the recognition means according to the signal received.

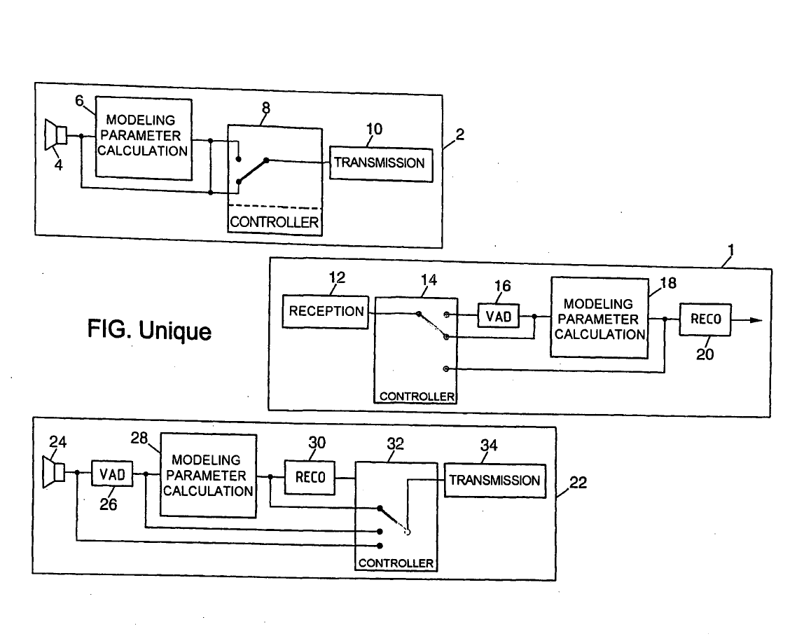

The present invention relates to the domain of voice control of applications, performed on user terminals, thanks to the implementation of speech recognition means. The user terminals considered are all devices equipped with a speech input means, normally a microphone, which has capacities to process this sound, and connected to one or more servers via a transmission channel. This involves, for example, control and remote control devices used in intelligent home applications, in automobiles (control of automobile radio or other vehicle functions), in PCs or telephone sets. The field of applications concerned is essentially the field in which the user controls an action, requests information or wishes to interact remotely using a voice command. The use of voice commands does not exclude the existence in the. user terminal of other means of action (multimode system), and feedback of information, status reports or responses may be provided in combined visual, audible, olfactory or any other humanly perceptible form.

Generally speaking, the means for implementing speech recognition comprise means for obtaining an audio signal, acoustic analysis means which extract modeling parameters, and finally recognition means which compare these calculated modeling parameters with models and propose the form stored in the models which can be associated with the signal in the most probable manner. Optionally, means for voice activation detection VAD may be used. These detect sequences which correspond to speech and which are to be recognized. They extract speech segments from the input audio signal outside voice inactivity periods, said segments then being processed by modeling parameter calculation means.

More specifically, the invention relates to the interactions between the three speech recognition modes, referred to as on-board, centralized and distributed.

In an on-board speech recognition mode, all the means for performing the speech recognition are located in the user terminal. The limitations of this recognition mode are therefore linked in particular to the performance of the on-board processors, and to the memory available for storing the speech recognition models. Conversely, this mode authorizes autonomous operation, with no connection to a server, and is therefore susceptible to substantial development linked to the reduction in the cost of the processing capacity.

In a centralized speech recognition mode, the entire speech recognition procedure and the recognition models are located and executed on one computer, generally referred to as a voice server, which can be accessed by the user terminal. The terminal simply transmits a speech signal to the server. This method is used in particular in applications offered by telecommunications operators. A basic terminal may thus access advanced, voice-activated services. Numerous types of speech recognition (robust, flexible, very large vocabulary, dynamic vocabulary, continuous speech, single or multiple speakers, a plurality of languages, etc.) may be implemented in a speech recognition server. In fact, centralized machines have substantial and increasing model storage capacities, working memory sizes and computing powers.

In a distributed speech recognition mode, the acoustic analysis means are installed in the user terminal, whereas the recognition means are located in the server. In this distributed mode, a noise reduction function associated with the modeling parameter calculation means may advantageously be implemented at the source. Only the modeling parameters are transmitted, enabling a substantial gain in transmission throughput, which is particularly advantageous for multimode applications. Moreover, the signal to be recognized may be more effectively protected against transmission errors. optionally, voice activation detection (VAD) may also be installed so that the modeling parameters are transmitted only during speech sequences, offering the advantage of a significant reduction in active transmission duration. Distributed speech recognition furthermore allows speech and data, particularly text, image or video signals to be carried on the same transmission channel. The transmission network may, for example, be of the IP, GPRS, WLAN or Ethernet type. This mode also offers the benefits of protection and correction procedures to prevent losses of packets constituting the signal transmitted to the server. However, it requires the availability of data transmission channels, with a strict transmission protocol.

The invention proposes a speech recognition system comprising user terminals and servers which combine the different functions offered by on-board, centralized and distributed speech recognition modes, to offer maximum efficiency, user-friendliness and ergonomics to users of multimode services in which voice control is used.

U.S. Pat. No. 6,487,534-B1 describes a distributed speech recognition system comprising a user terminal which has voice activation detection means, modeling parameter calculation means and recognition means. This system furthermore comprises a server which also has recognition means. The principle described involves the implementation of at least a first recognition phase in the user terminal. In a second, optional phase, the modeling parameters calculated in the terminal are sent to the server, in order, in particular, to determine, in this instance thanks to the recognition means of the server, a form stored in the models of said server and associated with the transmitted signal.

The object envisaged by the system described in the cited document is to reduce the load in the server. As a result, however, the terminal must implement the modeling parameter calculation locally before possibly transmitting said parameters to the server. There are, however, circumstances in which, for reasons of load management or for application-related reasons, it is preferable to implement this calculation in the server.

As a result, in a system according to the document cited above, the channels used for transmission of the modeling parameters to be recognized must invariably be channels suitable for transmission of this type of data. However, such channels with a very strict protocol are not necessarily continuously available on the transmission network. For this reason, it is advantageous to be able to use conventional audio signal transmission channels in order to avoid delaying or blocking the recognition process initiated in the terminal.

One object of the present invention is to propose a distributed system which is less adversely affected by the limitations cited above.

Thus, according to a first aspect, the invention proposes a distributed speech recognition system comprising at least one user terminal and at least one server suitable for communication with one another via a telecommunications network, in which the user terminal comprises:
means for obtaining an audio signal to be recognized;
first audio signal modeling parameter calculation means; and
first control means for selecting at least one signal to be transmitted to the server, from the audio signal to be recognized and a signal indicating the calculated modeling parameters.
   and in which the server comprises:
means for receiving the selected signal originating from the user terminal;
second input signal modeling parameter calculation means;
recognition means for associating at least one stored form with input parameters; and
second control means for controlling the second calculation means and the recognition means, in order,
   if the selected signal received by the reception means is an audio signal, to activate the second parameter calculation means by addressing the selected signal to them as an input signal, and to address the parameters calculated by the second calculation means to the recognition means as input parameters, and
   if the selected signal received by the reception means indicates modeling parameters, to address said indicated parameters to the recognition means as input parameters.

Thus, the system according to the invention enables the transmission from the user terminal to the server of either the audio signal (compressed or uncompressed), or the signal supplied by the modeling parameter calculation means of the terminal. The choice of transmitted signal may be defined either by the current application type, or by the status of the network, or following coordination between the respective control means of the terminal and the server.

A system according to the invention gives the user terminal the capacity to implement the modeling parameter calculation in the terminal or in the server, according, for example, to input parameters which the control means have at a given time. This calculation may also be implemented in parallel in the terminal and in the server.

A system according to the invention enables voice recognition to be performed from the different types of terminal coexisting within the same network, for example:
terminals which have no local recognition means (or whose local recognition means are inactive), in which case the audio signal is transmitted for recognition to the server;
terminals which have voice activation detection means without modeling parameter calculation means, or recognition means (or whose parameter calculation means and recognition means are inactive), and which transmit to the server for recognition an original audio signal or an audio signal representing speech segments extracted from the audio signal outside voice inactivity periods,
and servers which, for example, have only recognition means, without modeling parameter calculation means.

Advantageously, the means for obtaining the audio signal from the user terminal may furthermore comprise voice activation detection means in order to extract speech segments from the original audio signal outside periods of voice inactivity. The terminal control means then select at least one signal to be transmitted to the server, from an audio signal representing speech segments and the signal indicating the calculated modeling parameters.

The terminal control means are advantageously adapted in order to select at least one signal to be transmitted to the server from at least the original audio signal, the audio signal indicating the speech segments extracted from the original audio signal and the signal indicating calculated modeling parameters. In the server, the control means are adapted in order to control the calculation means and the recognition means in order, if the selected signal received by the reception means represents speech segments extracted by the activation detection means of the terminal, to activate the parameter calculation means of the server by addressing the selected signal to them as an input signal, and to address the parameters calculated by these calculation means to the recognition means as input parameters.

In a preferred embodiment, the server furthermore comprises voice activation detection means for extracting speech segments from a received audio signal outside voice inactivity periods. In this case, in the server, the control means are adapted to control the calculation means and the recognition means in order,
if the selected signal received by the reception means is an audio signal:
   if the received audio signal represents speech segments following voice activation detection, to activate the second parameter calculation means by addressing the selected signal to them as an input signal, then to address the parameters calculated by the second parameter. calculation means to the recognition means as input parameters;
   if not, to activate the voice activation detection means of the server by addressing the selected signal to them as an input signal, then to address the segments extracted by the voice activation detection means to the second parameter calculation means as input parameters, then to address the parameters calculated by the second parameter calculation means to the recognition means as input parameters;
if the selected signal received by the reception means indicates modeling parameters, to address said indicated parameters to the recognition means as input parameters.

Advantageously, the user terminal furthermore comprises recognition means to associate at least one stored form with input parameters.

In this latter case, the control means of the terminal can be adapted to select a signal to be transmitted to the server according to the result supplied by the recognition means of the terminal. And moreover, the user terminal may comprise storage means adapted to store a signal in the terminal in order to be able, in the event that the result of the local recognition in the terminal is not satisfactory, to send the signal for recognition by the server.

Advantageously, the control means of the terminal can be adapted to select a signal to be transmitted to the server independently of the result supplied by first recognition means.

It must be noted that the control means of a terminal may switch from one to the other of the two modes described in the two paragraphs above, according, for example, to the application context or the status of the network.

The control means of the server preferably interwork with the control means of the terminal. The terminal may thus avoid sending, for example, an audio signal to the server if there is already a substantial load in the parameter calculation means of the server. In one possible embodiment, the control means of the server are configured to interwork with the means of the terminal in order to adapt the type of signals sent by the terminal according to the respective capacities of the network, the server and the terminal.

The calculation and recognition means of the terminal may be standardized or proprietary.

In a preferred embodiment, at least some of the recognition and parameter calculation means in the terminal have been supplied to it by downloading, in the form of code executable by the terminal processor, for example from the server.

According to a second aspect, the invention proposes a user terminal to implement a distributed speech recognition system according to the invention.

According to a third aspect, the invention proposes a server to implement a distributed speech recognition system according to the invention.

Other characteristics and advantages of the invention will be revealed by reading the description which follows. This description is purely illustrative, and must be read with reference to the attached drawings, in which:

the single FIGURE is a diagram representing a system in an embodiment of the present invention.

The system shown in the single FIGURE comprises a server 1 and a user terminal 2, which communicate with one another via a network (not shown) which has channels for the transmission of voice signals and for the transmission of data signals.

The terminal 2 comprises a microphone 4, which picks up the speech to be recognized from a user in the form of an audio signal. The terminal 2 also comprises a modeling parameter calculation module 6, which, in a manner known per se, performs an acoustic analysis which enables the extraction of the relevant parameters of the audio signal, and which may possibly advantageously perform a noise reduction function. The terminal 2 comprises a controller 8, which selects a signal from the audio signal and a signal indicating the parameters calculated by the parameter calculation module 6. It furthermore comprises an interface 10 for transmission on the network of the selected signal to the server.

The server 1 comprises a network interface 12 to receive the signals which are addressed to it, a controller 14 which analyses the received signal and then routes it selectively to one processing module among a plurality of modules 16, 18, 20. The module 16 is a voice activation detector which detects the segments corresponding to speech which are to be recognized. The module 18 calculates modeling parameters in a manner similar to the calculation module 6 of the terminal. However, the calculation model may be different. The module 20 executes a recognition algorithm of a known type, for example based on hidden Markov models with a vocabulary, for example, of more than 100,000 words. This recognition engine 20 compares the input parameters to speech models which represent words or phrases, and determines the optimum associated form, taking account of syntactic models which describe concatenations of expected words, lexical models which define the different pronunciations of the words, and acoustic models representing pronounced sounds. These models are, for example, multi-speaker models, capable of recognizing speech with a high degree of reliability, independently of the speaker.

The controller 14 controls the VAD module 16, the parameter calculation module 18 and the recognition engine 20 in order:
a/ if the signal received by the reception interface 12 is an audio signal and does not indicate speech segments obtained by voice activation detection, to activate the module VAD 16 by addressing the received signal to it as an input signal, then to address the speech segments extracted by the VAD module 16 to the parameter calculation module 18 as input parameters, then to address the parameters calculated by these parameter calculation means 18 to the recognition engine 20 as input parameters;
b/ if the signal received by the reception interface 12 is an audio signal and indicates speech segments following voice activation detection, to activate the parameter calculation module 18 by addressing the received signal to it as an input signal, then to address the parameters calculated by this parameter calculation module 18 to the recognition engine 20 as input parameters;
c/ if the signal received by the reception interface 12 indicates modeling parameters, to address said indicated parameters to the recognition engine 20 as input parameters.

For example, if the user of the terminal 1 uses an application enabling requests for information on the stock exchange and states: “closing price for the last three days of the value Lambda”, the corresponding audio signal is picked up by the microphone 4. In the embodiment of the system according to the invention, this signal is then, by default, processed by the parameter calculation module 6, then a signal indicating the calculated modeling parameters is sent to the server 1.

When, for example, problems of availability of data channels or of the calculation module 6 occur, it is the output audio signal of the microphone 4 which the controller 8 then selects to transmit it to the server 1.

The controller may also be adapted to systematically send a signal indicating the modeling parameters.

The server receives the signal with the reception interface 12, then, in order to perform the speech recognition on the received signal, performs the processing indicated in a/ or b/ if the signal sent by the terminal 1 is an audio signal, or the processing indicated in c/ if the signal sent by the terminal 1 indicates modeling parameters.

The server according to the invention is also suitable for performing speech recognition on a signal transmitted by a terminal which does not have modeling parameter calculation means or recognition means, and which possibly has voice activation detection means.

Advantageously, in one embodiment of the invention, the system may furthermore comprise a user terminal 22 which comprises a microphone 24 similar to that of the terminal 2, and a voice activation detection module 26. The function of the module 26 is similar to that of the voice activation detection module 16 of the server 1. However, the detection model may be different. The terminal 22 comprises a modeling parameter calculation module 28, a recognition engine 30 and a controller 32. It comprises an interface 10 for transmission on the network to the server of the signal selected by the controller 32.

The recognition engine 30 of the terminal may, for example, process a vocabulary of less than 10 words. It may function in single-speaker mode and may require a preliminary learning phase based on the voice of the user.

The speech recognition may be carried out in different ways:
exclusively in the terminal, or
or exclusively in the server, or
partially or totally in the terminal and also, in an alternative or simultaneous manner, partially or totally in the server.

When a choice has to be made regarding the form finally used, between an associated form supplied by the recognition module of the server and an associated form supplied by those of the terminal, it may be made on the basis of different criteria, which may vary from one terminal to another, but also from one application to another, or from one given context to another. These criteria may, for example, give priority to the recognition carried out in the terminal, or to the associated form presenting the highest level of probability, or the most quickly determined form.

The manner in which this recognition is carried out may be fixed in the terminal in a given mode, or it may vary, in particular, according to criteria linked to the application concerned, to problems relating to the load of the different means in the terminal and the server, or to problems of availability of voice or data transmission channels. The controllers 32 and 14 located respectively in the terminal and the server translate the manner in which the recognition must be carried out.

The controller 32 of the terminal is adapted to select a signal from the original output audio signal of the microphone 24, an audio signal representing speech segments extracted by the VAD module 26 and a signal indicating modeling parameters 28. Depending on the cases concerned, the processing in the terminal will or will not be carried out after the processing step of the terminal which supplies the signal to be transmitted.

For example, an embodiment can be considered in which the VAD module 26 of the terminal is designed, for example, to quickly detect command words and the VAD module 16 of the server may be slower, but is designed to detect entire phrases. An application in which the terminal 22 carries out recognition locally and simultaneously instigates recognition by the server on the basis of the transmitted audio signal enables, in particular, accumulation of the advantages of each voice detection module.

An application in which the recognition is carried out exclusively locally (terminal) or exclusively remotely (centralized server) will now be considered, on the basis of keywords enabling changeover:

The recognition in progress is initially local: the user states: “call Antoine”, Antoine being listed in the local directory. He then states “messaging”, a keyword which is recognized locally and which initiates changeover to recognition by the server. The recognition is now remote. He states “search for the message from Josiane”. When said message has been listened to, he states “finished”, a keyword which again initiates changeover of the application to local recognition.

The signal transmitted to the server to carry out the recognition there was an audio signal. In a different embodiment, it could indicate the modeling parameters calculated in the terminal.

An application in which the recognition in the terminal and the recognition in the server alternate will now be considered. The recognition is first carried out in the terminal 22 and the signal following voice detection is stored. If the response is consistent, i.e. if there is no rejection by the recognition module 30 and if the recognized signal is valid from the application point of view, the local application in the terminal moves on to the following application phase. If the response is not consistent, the stored signal is sent to the server to carry out the recognition on a signal indicating speech segments following voice activation detection on the audio signal (in a different embodiment, the modeling parameters could be stored).

Thus, the user states “call Antoine”; the entire processing in the terminal 22 is carried out with storage of the signal. The signal is successfully recognized locally. He then states “search for the message from Josiane”; the recognition in the terminal fails; the stored signal is then transmitted to the server. The signal is successfully recognized and the requested message is played.

In a different application, the recognition is carried out simultaneously in the terminal and also, independently of the result of the local recognition, in the server. The user states “call Antoine”. The recognition is carried out at two levels. As the local processing interprets the command, the remote result is not considered. The user then states “search for the message from Josiane”, which generates a local failure, which is successfully recognized in the server.

In one embodiment, the recognition engine 30 of the terminal 22 is an executable program downloaded from the server by conventional data transfer means.

Advantageously for a given application of the terminal 22, recognition models of the terminal can be downloaded or updated during an application session connected to the network.

Other software resources useful for speech recognition can also be downloaded from the server 1, such as the modeling parameter calculation module 6, 28 or the voice activation detector 26.

Other examples could be described, implementing, for example, applications associated with automobiles, household electrical goods, multimedia.

As presented in the exemplary embodiments described above, a system according to the invention enables optimized use of the different resources required for the processing of speech recognition and present in the terminal and in the server.

1. A distributed speech recognition system comprising at least one user terminal and at least one server suitable for communication with one another via a telecommunications network, wherein the user terminal comprises:
means for obtaining an audio signal to be recognized;
first audio signal modeling parameter calculation means; and
first control means for selecting at least one signal to be transmitted to the server, from the audio signal to be recognized and a signal indicating the calculated modeling parameters.
and wherein the server comprises:
means for receiving the selected signal originating from the user terminal;
second input signal modeling parameter parameter calculation means;
recognition means for associating at least one stored form with input parameters; and
second control means for controlling the second calculation means and the recognition means in order,
if the selected signal received by the reception means is an audio signal, to activate the second parameter calculation means by addressing the selected signal to them as an input signal, and to address the parameters calculated by the second calculation means to the recognition means as input parameters, and
if the selected signal received by the reception means indicates modeling parameters, to address said indicated parameters to the recognition means as input parameters.

2. The system as claimed in claim 1, wherein the means for obtaining the audio signal to be recognized comprise voice activation detection means to produce the signal to be recognized in the form of extracts of an original audio signal, outside speech segment of voice inactivity periods.

3. The system as claimed in claim 2, wherein the first control means are adapted to select the signal to be transmitted to the server from at least the original audio signal, the audio signal to be recognized in the form of segments extracted by the voice activation detection means and the signal indicating modeling parameters calculated by the first parameter calculation means.

4. The system as claimed in claim 1, wherein:
the server furthermore comprises voice activation detection means for extracting speech segments from an audio signal outside voice inactivity periods; and
the second control means are adapted to control the second calculation means and the recognition means if the selected signal received by the reception means is an audio signal, in order,
if the audio signal represents speech segments following voice activation detection, to activate the second parameter calculation means by addressing the selected signal to them as an input signal, then to address the parameters calculated by the second parameter calculation means to the recognition means as input parameters;
if not, to activate the voice activation detection means of the server by addressing the received signal to them as an input signal, then to address the segments extracted by the second voice activation detection means to the second parameter calculation means as input signal, then to address the parameters calculated by the second parameter calculation means to the recognition means as input parameters.

5. The system as claimed in claims 1, wherein the user terminal furthermore comprises recognition means in order to associate at least one stored form with the modeling parameters calculated by the first calculation means.

6. The system as claimed in claim 5, wherein the first control means are adapted to select the signal to be transmitted to the server according to the result supplied by the terminal recognition means.

7. The system as claimed in claim 5, wherein the user terminal furthermore comprises storage means adapted to store the audio signal to be recognized or the modeling parameters calculated by the first parameter calculation means.

8. The system as claimed in claim 5, wherein the first control means are adapted to select a signal to be transmitted to the server independently of the result supplied by the recognition means of the terminal.

9. A user terminal in a distributed speech recognition system comprising one server suitable for communication with said user terminal said user terminal comprising:
means for obtaining an audio signal to be recognized;
audio signal modeling parameter calculation means; and
first control means for selecting at least one signal to be transmitted to a server, from the audio signal to be recognized and a signal indicating calculated modeling parameters.

10. The user terminal as claimed in claim 9, wherein at least part of the parameter calculation means is downloaded from the server.

11. The terminal as claimed in claim 9, furthermore comprising recognition means to associate at least one stored form with the modeling parameters.

12. The user terminal as claimed in claim 11, wherein at least part of the recognition means is downloaded from the server.

13. A server in a distributed speech recognition system comprising at least one user terminal adapted for communication with said server said server comprising:
means for receiving, from a user terminal, a signal selected at said terminal;
input signal modeling parameter calculation means;
recognition means for associating at least one stored form with input parameters; and
control means for controlling the second calculation means and the recognition means, in order,
if the selected signal received by the reception means is an audio signal, to activate the parameter calculation means by addressing the selected signal to them as an input signal, and to address the parameters calculated by the calculation means to the recognition means as input parameters, and
if the selected signal received by the reception means indicates modeling parameters, to address said indicated parameters to the recognition means as input parameters.

14. The server as claimed in claim 13, comprising means for downloading voice recognition software resources via the telecommunications network to a terminal at least part of the first parameter calculation means or recognition means of the terminal.

15. The server as claimed in claim 14, comprising means for downloading voice recognition software resources via the telecommunications network to a terminal.

16. The server as claimed in claim 15, wherein said resources comprise at least one module from: a VAD module, an audio signal modeling parameter calculation module and a recognition module for associating at least one stored form with modeling parameters.
